(19) United States
(12) Patent Application Publication
(10) Pub. No.: US 2015/0170278 A1
(43) Pub. Date: Jun. 18, 2015

(54) METHOD OF REPORTING INFORMATION REGARDING A TRADE OF SECURITIES

(71) Applicant: John J. McGonegal, Gladstone, NJ (US)

(72) Inventor: John J. McGonegal, Gladstone, NJ (US)

(21) Appl. No.: 14/569,180

(22) Filed: Dec. 12, 2014

Related U.S. Application Data
(60) Provisional application No. 61/915,074, filed on Dec. 12, 2013.

(51) Int. Cl. G06Q 40/04

(52) U.S. Cl. CPC G06Q 40/04

(57) ABSTRACT

A method of reporting information regarding the trade of equity securities is provided. A user may first enter at least one recipient to a database via the software. Each recipient may include a designator. A securities order or trade is placed forming a transaction. Data from the transaction is extracted and a transaction message, such as an email, is populated with the data. The transaction message is sent to the recipients using the designator. The transaction message may be sent over the internet.

### CROSS-REFERENCE TO RELATED APPLICATION

This application claims the benefit of priority of U.S. provisional application No. 61/915,074, filed Dec. 12, 2013, the contents of which are herein incorporated by reference.

### BACKGROUND OF THE INVENTION

The present invention relates to securities exchanges and, more particularly, to a method of reporting information regarding the trade of securities.

Securities market is a component of the wider financial market where securities can be bought and sold between subjects of the economy, on the basis of demand and supply. Securities markets encompasses equity markets, bond markets, and derivatives markets where prices can be determined and participants both professional and non professionals can meet.

It is desirable for investors and traders to communicate in real time with each other regarding trades. Currently, communication is done after the trade has been completed and is not verified. Further, investment firms publish favorable trades performed by their traders, while investors are also interested in unfavorable trades performed by those traders.

As can be seen, there is a need for an instant communication of accurate information regarding the trading of securities.

### SUMMARY OF THE INVENTION

In one aspect of the present invention, a method of reporting information regarding a trade of securities comprises: prompting a user to enter at least one recipient to a database via software executed on a computer, wherein the at least one recipient comprises a designator; trading equity securities via software executed on a computer, and thereby forming a transaction; extracting data about the transaction via software executed on a computer; creating a transaction message comprising the data via software executed on a computer; and sending the transaction message to the at least one recipient using the designator via software executed on a computer.

These and other features, aspects and advantages of the present invention will become better understood with reference to the following drawings, description and claims.

### BRIEF DESCRIPTION OF THE DRAWINGS

FIG. 1 is a flow chart of a method of an embodiment of the present invention; and

FIG. 2 is a detailed flow chart of the flow chart of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The present invention allows traders (individuals or professionals) to send an email to a pre-determined and pre-populated list as soon as they execute a trade. The present invention ties an order placed electronically to a commercial email application. As the trade is entered, an email is automatically generated detailing the order and sent to a pre-populated distribution list. The present invention solves the problem of manually telling others what you have done and eliminates traders being less than forthcoming about their trades.

An example of the present invention may include the following. The email details the order and transaction that was placed. If the trader buys 1000 AAPL at the market for instance, the email will detail the time sent, the amount of money involved, the type of asset, and the like. The order to buy above goes into an email as it is entered or milliseconds after. The information can be verified and immediately shared with the distribution list. The present invention may thereby prevent the manipulation of what trader has done or what order the trader has entered in the marketplace.

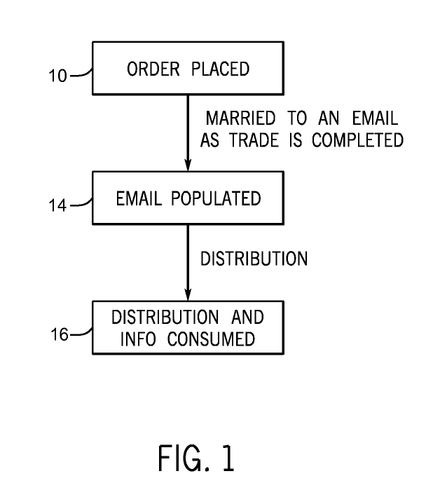

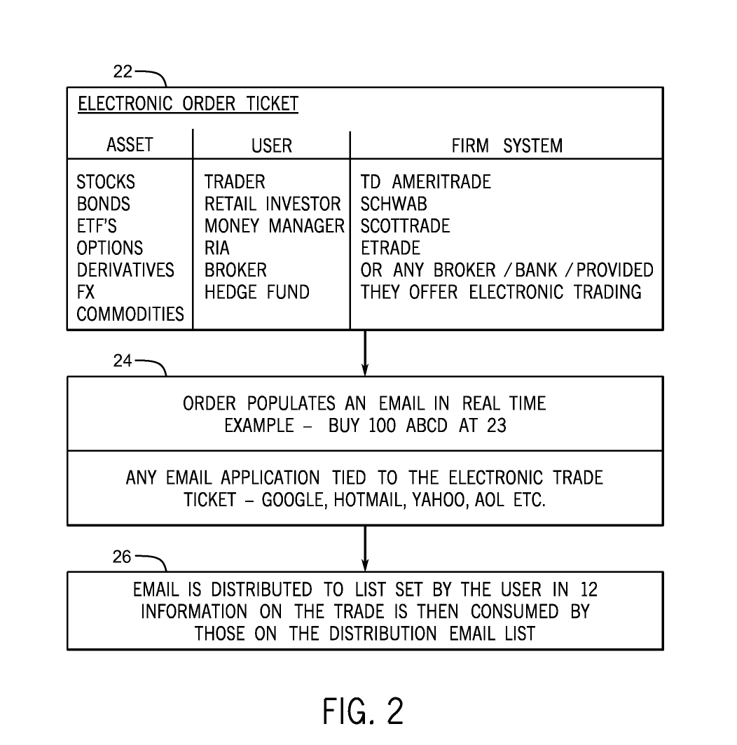

Referring to FIGS. 1 and 2, the method of reporting information regarding the trade of equity securities may include the following. A user may first enter at least one recipient to a database via the software. Each recipient may include a designator. A securities order or trade is placed 10 forming a transaction. Data from the transaction is extracted and a transaction message, such as an email, is populated 14. The distribution and information is consumed 16. Therefore, the transaction message is sent to the recipients using the designator. The transaction message may be sent over the internet.

As mentioned above, the at least one recipient may be a plurality of recipients each including their one unique designator. The recipients may be clients/investors of an investment firm. The clients may be entered into the database as recipients by the investment firm to receive transactions performed on the client's behalf or for other clients. The unique designator may include an email address or a phone number. Therefore, once the transaction has been completed and the transaction message has been generated, the transaction message may be sent as a text message or an email message.

In certain embodiments, a template message may be created prior to the trading of securities. The template message may be entered to the database via software executed on a computer. The template message may include an email or test message with a plurality of input categories, or information blocks. The template message may include a plurality of texts for each input category identifying the type of data presented within the input categories. Prior to the transaction, the input categories may be empty. Once the transaction has been performed, the data is extracted from the transaction, and the input categories are automatically populated by the corresponding data. Once the data has populated the input categories, the transaction message is complete and is ready to send to the recipients.

As illustrated in FIG. 2, the data may be extracted from an electronic ticket order 22 generated from the transaction. The data may include, but is not limited to, a date of the transaction, a time of the transaction, an amount of money used in the transaction, a type of asset exchanged in the transaction, a type of user that made the transaction, a type of firm used to make the transaction, an amount of the asset exchanged in the transaction, and a business name of the original asset holder. Each of the data is extracted from the electronic ticket order 22 and populated in the corresponding input category. The transaction message, either an email or text message, is generated once the template message has been fully populated 24. The transaction message is then distributed to the recipients 26.

The type of asset exchanged in the transaction may include, but is not limited to, stocks, bonds, exchange traded funds (ETF's), options, derivatives, foreign exchange (FX), commodities and the like. The type of user that made the transaction may include, but is not limited to, traders, retail investors, money managers, registered investment advisors (RIA), brokers, hedge fund holders, and the like. The type of firm used to make the transaction may include any firm such as, but not limited to, TD Ameritrade®, Schwab®, Scottrade®, Etrade® or any broker or bank that provides electronic trading. The amount of the asset exchanged in the transaction may include an amount of stocks, shares, equity and the like.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method of reporting information regarding a trade of securities comprising:
prompting a user to enter at least one recipient to a database via software executed on a computer, wherein the at least one recipient comprises a designator;
trading securities via software executed on a computer, and thereby forming a transaction;
extracting data about the transaction via software executed on a computer;
creating a transaction message comprising the data via software executed on a computer; and
sending the transaction message to the at least one recipient using the designator via software executed on a computer.

2. The method of claim 1, wherein the at least one recipient is a plurality of recipients each comprising a unique designator.

3. The method of claim 1, wherein the designator comprises at least one of a phone number and an e-mail address.

4. The method of claim 1, further comprising the step of prompting the user to enter a template message to the database via software executed on a computer prior to trading equity securities.

5. The method of claim 4, further comprising the step of entering the data to the template message and thereby creating the transaction message.

6. The method of claim 5, wherein the template message comprises a plurality of input categories.

7. The method of claim 6, wherein the data about the transaction comprises at least one of a date of the transaction, a time of the transaction, an amount of money used in the transaction, a type of asset exchanged in the transaction, an amount of the asset exchanged in the transaction, a type of user that made the transaction, a type of firm used to make the transaction, and a name of the original asset holder.

8. The method of claim 7, wherein the data is entered into a corresponding input category.

9. The method of claim 1, wherein the data is generated from an electronic order ticket of the transaction.
